(19) United States
(12) Patent Application Publication
(10) Pub. No.: US 2019/0004803 A1
(43) Pub. Date: Jan. 3, 2019

(54) STATISTICAL CORRECTION FOR BRANCH PREDICTION MECHANISMS

(71) Applicant: QUALCOMM Incorporated, San Diego, CA (US)

(72) Inventor: Rami Mohammad A. AL SHEIKH, Morrisville, NC (US)

(21) Appl. No.: 15/640,444

(22) Filed: Jun. 30, 2017

(51) Int. Cl. G06F 9/38; G06F 9/30

(52) U.S. Cl. CPC G06F 9/3806; G06F 9/30058

(57) ABSTRACT

Systems and methods for branch prediction include a processor configured to execute at least one branch instruction. The processor includes a branch prediction mechanism configured to provide a branch prediction for the at least one branch instruction and a statistical correction table (SCT) configured to indicate whether a branch prediction accuracy of the branch prediction provided by the branch prediction mechanism is worse than a statistical bias for a branch instruction. An execution pipeline of the processor is configured to speculatively executing the branch instruction in a direction corresponding to the statistical bias if, at least, the branch prediction accuracy is worse than the statistical bias.

### FIELD OF DISCLOSURE

Disclosed aspects are directed to branch prediction in processing systems. More specifically, exemplary aspects are directed to improving branch prediction accuracy using statistical correction.

### BACKGROUND

Processing systems may employ instructions which cause a change in control flow, such as conditional branch instructions. The direction of a conditional branch instruction is based on how a condition evaluates, but the evaluation may only be known deep down an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, or a “not-taken” path which starts at the next sequential address after the conditional branch instruction.

When the condition is evaluated and the actual branch direction is determined, if the branch was mispredicted, (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include one or more state machines which may be trained with a history of evaluation of past and current branch instructions. But these branch prediction mechanisms can fail to accurately predict the direction of branch instructions in some scenarios. For example, accuracy of branch prediction may suffer in situations where there is insufficient history to provide a reliable branch prediction for a particular branch instruction or if the branch instruction being predicted does not correlate with available history. Accordingly, in some situations, branch prediction mechanisms may not mitigate the above-mentioned penalties associated with mispredictions and execution of wrong path instructions.

Moreover, in some cases, the conventional branch prediction mechanisms for a branch instruction may even be less accurate than a statistical bias in the behavior of the branch instruction. For example, if a branch instruction is statistically seen to be taken 90% of the time the branch instruction is executed, then predicting the branch instruction to always be consistent with its statistical bias (either taken or not-taken) would only result in the branch instruction being mispredicted 10% of the time. Thus, if a branch prediction mechanism results in mispredicting the branch instruction more than 10% of the time, then that branch prediction mechanism would be worse (i.e., less accurate) than following the branch instruction's statistical bias each time the branch instruction is executed.

Accordingly, there is a recognized need in the art for improving the accuracy of branch prediction mechanisms, while avoiding the aforementioned drawbacks of conventional implementations.

### SUMMARY

Exemplary aspects of the invention are directed to systems and method for branch prediction. Aspects include determining whether a branch prediction accuracy provided by a branch prediction mechanism is worse than a statistical bias for a branch instruction, for example, by using from a statistical correction table (SCT). An entry in SCT for the branch instruction, if present, comprises indications of: a number of mispredictions by the branch prediction mechanism for the branch instruction; a number of times the branch instruction evaluated to a taken direction; and a number of times the branch instruction evaluated to a not-taken direction. If, at least, the branch prediction accuracy is worse than the statistical bias, the branch instruction may be speculatively executed in a direction corresponding to the statistical bias. One or more additional heuristics may be used in the speculative execution.

For example, an exemplary aspect is directed to a method of branch prediction, the comprising determining whether a branch prediction accuracy provided by a branch prediction mechanism is worse than a statistical bias for a branch instruction; and if, at least, the branch prediction accuracy is worse than the statistical bias, speculatively executing the branch instruction in a direction corresponding to the statistical bias.

Another exemplary aspect is directed to an apparatus comprising a processor configured to execute at least one branch instruction. The processor comprises a branch prediction mechanism configured to provide a branch prediction for the at least one branch instruction; a statistical correction table (SCT) configured to indicate whether a branch prediction accuracy of the branch prediction provided by the branch prediction mechanism is worse than a statistical bias for a branch instruction; and an execution pipeline configured to speculatively execute the branch instruction in a direction corresponding to the statistical bias if, at least, the branch prediction accuracy is worse than the statistical bias.

Yet another exemplary aspect is directed to an apparatus comprising means for determining whether a branch prediction accuracy provided by a branch prediction mechanism is worse than a statistical bias for a branch instruction, and means for speculatively executing the branch instruction in a direction corresponding to the statistical bias if, at least, the branch prediction accuracy is worse than the statistical bias.

Yet another exemplary aspect is directed to a non-transitory computer readable storage medium comprising code, which, when executed by a processor causes the processor to perform operations for branch prediction, the non-transitory computer readable storage medium comprising: code for determining whether a branch prediction accuracy provided by a branch prediction mechanism is worse than a statistical bias for a branch instruction, and code for speculatively executing the branch instruction in a direction corresponding to the statistical bias if, at least, the branch prediction accuracy is worse than the statistical bias.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a processing system according to aspects of this disclosure

FIG. 2 illustrates a statistical correction table, according to aspects of this disclosure.

FIG. 3 illustrates a sequence of events pertaining to an exemplary method according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to a statistical corrector that is provided to augment accuracy of conventional branch prediction mechanisms based on history and state machines, for example. In an exemplary implementation, the statistical corrector is designed to be fast and free from interfering in the critical path for branch prediction. Various exemplary heuristics are disclosed for determining when to use a branch prediction provided by the statistical corrector.

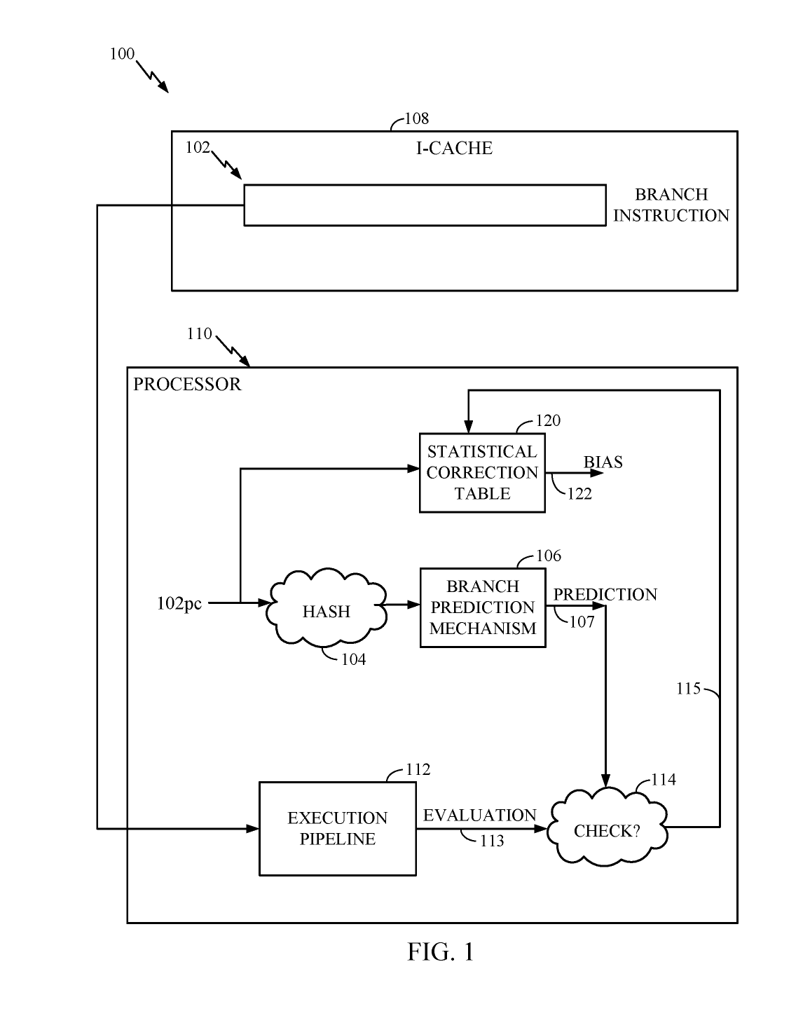

With reference now to FIG. 1, an exemplary processing system 100 in which aspects of this disclosure may be employed, is shown. Processing system 100 is shown to comprise processor 110 coupled to instruction cache 108. Although not shown in this view, additional components such as functional units, input/output units, interface structures, memory structures, etc., may also be present but have not been explicitly identified or described as they may not be germane to this disclosure. As shown, processor 110 may be configured to receive instructions from instruction cache 108 and execute the instructions using for example, execution pipeline 112. Execution pipeline 112 may be configured may include one or more pipelined stages for performing instruction fetch, decode, and execute operations as known in the art. Representatively, a branch instruction is shown in instruction cache 108 and identified as instruction 102.

In an exemplary implementation, branch instruction 102 may have a corresponding address or program counter (PC) value of 102pc. Processor 110 is generally shown to include branch prediction mechanism 106, which may further include branch prediction units such as a history table comprising a history of behavior of prior branch instructions, state machines such as branch prediction counters, etc., as known in the art. When branch 102 is fetched by processor 110 for execution, logic such as hash 104 (e.g., implementing an XOR function) may utilize the address or PC value 102pc and/or other information from branch instruction 102 to access branch prediction mechanism and retrieve prediction 107, which represents a prediction (also referred to as a dynamic prediction) of branch instruction 102.

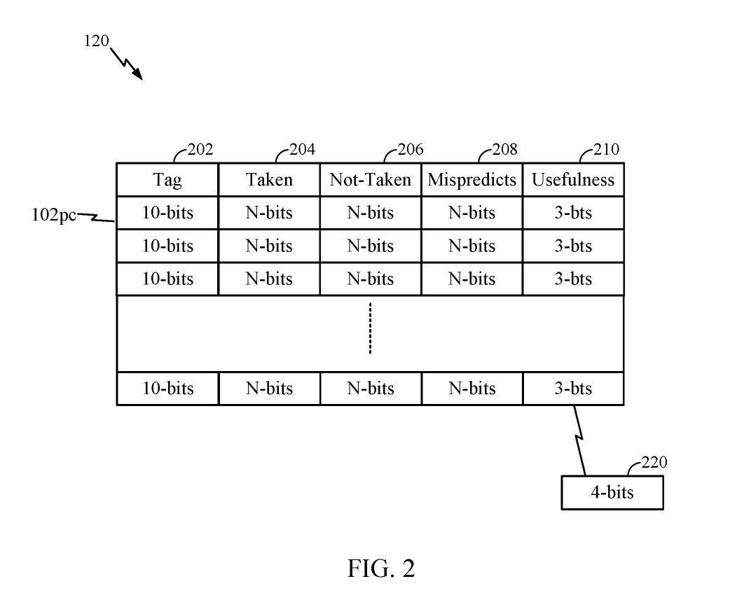

In exemplary aspects, processor 110 also includes statistical correction table (SCT) 120, an example implementation of which will be further described with reference to FIG. 2. SCT 120 may be indexed by PC value 102pc of branch instruction 102, for example, and provide bias 122, which is a statistical bias of branch instruction 102 (e.g., taken/not-taken). When and if exemplary conditions are satisfied, bias 122 may serve as the prediction for branch instruction 102 in lieu of prediction 107 provided by branch prediction mechanism 106.

Continuing with the description of FIG. 1, branch instruction 102 may be speculatively executed in execution pipeline 112 (based on a direction derived from either prediction 107 or bias 122 as will be explained later). After traversing one or more pipeline states, an actual evaluation of branch instruction 102 will be known, and this is shown as evaluation 113. Evaluation 113 is compared with prediction 107 in prediction check block 114 to determine whether evaluation 113 matched prediction 107 (i.e., branch instruction 102 was correctly predicted) or mismatched prediction 107 (i.e., branch instruction 102 was mispredicted). In an example implementation, bus 115 comprises information comprising the correct evaluation 113 (taken/not-taken) as well as whether branch instruction 102 was correctly predicted or mispredicted. The information on bus 115 may be supplied to SCT 120.

Referring now to FIG. 2 in conjunction with FIG. 1, an example implementation of SCT 120 is shown. In exemplary aspects, SCT 120 is configured to capture the statistical bias of branch instructions such as branch instruction 102. SCT 120 may contain one or more entries. SCT 120 is indexed and tagged using the address or program counter (PC) of branch instructions, e.g., using 102pc, which means that each branch instruction whose direction is to be predicted (e.g., conditional branch instructions) may be assigned an associated entry in SCT 120.

Each entry of SCT 120 may comprise the five fields shown in FIG. 2, in one example implementation. Focusing on one of the entries shown for branch instruction 102, associated with branch PC 102pc, tag 202 for the entry is a field configured to store lower order bits of the branch PC 102pc. Three other fields of the entry comprise counters, e.g., N-bit saturating counters, specifically identified as taken counter 204, not-taken counter 206, and mispredictions counter 208. In exemplary aspects, the relative values of these three counters (rather than their absolute values) may be pertinent and as such, the value of N may be selected as a relatively small number such as 8, which may be large enough to rationalize the relationship between the N-bit counters of each of the three fields 204, 206, and 208. In an implementation, if the most significant bit (MSB) of any of the N-bit counters turns from 0 to 1 (i.e., the value saturates), then the values of all three counters are halved or shifted to the right by one. This way, the relative nature of the values of taken counter 204, not-taken counter 206, and mispredictions counter 208 can be captured by the smaller, e.g., 8-bit counters even if their absolute values may overflow the available bit width of these counters.

Considering an example implementation of SCT 120 in more detail, taken counter 204 is configured to count a number of times branch instruction 102 is executed and found to be taken. In an aspect, taken counter 204 may be incremented based on information provided by bus 115 of FIG. 1 based on the evaluation 113 of branch instruction 102. Similarly, not-taken counter 206 is configured to count the number of times branch instruction 102 executed and was found to be not taken, wherein not-taken counter 206 may likewise be updated based on evaluation 113 of branch instruction 102.

Mispredictions counter 108 is configured to count the number of times the branch predictor mispredicted the branch direction (e.g., based on whether prediction check block 114 revealed that prediction 107 matches evaluation 113 or not).

Yet another field of the entry of SCT 120 as shown in FIG. 2 comprises usefulness counter 210. Usefulness counter 210 may be implemented as a saturating counter which may be smaller than the N-bit counters described above (e.g., usefulness counter 210 may be 3-bits). Usefulness counter 210 may be configured to count the number of times the statistical corrector prediction or bias 122 is correct (e.g., bias 122 matches evaluation 113) while prediction 107 from branch prediction mechanism 106 is incorrect (e.g., prediction 107 mismatches evaluation 113).

Using the above-described field, bias 122 may be provided by SCT 120 in the following manner. Considering the example of branch instruction 102, when branch instruction 102 is fetched, SCT 120 is indexed using the branch PC 102pc. Assuming that tag 202 matches the address of branch instruction 102 at the indexed entry of SCT 120, corresponding taken counter 204, not-taken counter 206, mispredictions counter 208, and usefulness counter 210 are read out. The values of these counters (i.e., taken counter 204, not-taken counter 206, mispredictions counter 208, and usefulness counter 210), may then be used to check if branch predictor accuracy is less than the statistical bias, using the following mechanism.

Branch prediction accuracy is considered to be worse than statistical bias 122 if the value of misprediction counter 208 is greater than the minimum of taken counter 204 and not-taken counter 206, and if usefulness counter 210 is greater than or equal to 0 (the above condition may be alternatively represented by the expression: misprediction counter 208>minimum (taken counter 204, not-taken counter 206) and if usefulness counter 210>=0). If the above condition is satisfied, i.e., if the accuracy of prediction 107 output by branch prediction mechanism 106 is determined to be worse than the accuracy offered by bias 122, then prediction 107 output by branch prediction mechanism 106 may be ignored or overridden and bias 122 may be used instead. In some aspects, branch instruction 102 may be speculatively executed using bias 122 rather than prediction 107 in this scenario if some additional heuristics are met. Speculatively executing branch instruction 102 using bias 122 may involve executing branch instruction 102 assuming that branch instruction 102 will be taken if the value of taken counter 204 is greater than the value of not-taken counter 206; or vice-versa, i.e., assuming that branch instruction 102 will be not-taken if the value of not-taken counter 206 is greater than the value of taken counter 204.

The following heuristics may be used to decide whether to use bias 122 instead of prediction 107 if branch prediction accuracy is considered to be worse than statistical bias 122. One example heuristic is, if usefulness counter 210 is greater than or equal zero, then bias 122 may be used for the speculative execution of branch instruction 102 instead of prediction 107. In alternative aspects, one or more of the following other heuristics may be used for selecting statistical prediction (e.g., bias 122) instead of the branch predictor prediction (e.g., prediction 107): if the branch prediction counter used by branch prediction mechanism 106 as known in the art, for branch instruction 102 is not saturated; if usefulness counter 210 is saturated; if the branch predictor accuracy during a previous epoch (calculated based on a fixed number of instructions executed or a number of clock cycles) was lower than a specified threshold (e.g., 2%), etc. Accordingly, selecting between prediction 107 and bias 122 may be based on relative accuracies of branch prediction mechanism 106 and statistical bias, as well as these one or more additional heuristics, in exemplary aspects.

It is recognized that in some instances, bias 122 may match prediction 107. In these cases, prediction 107 may be used in speculative execution of branch instruction 102, rather than bias 122. In yet other aspects, bias 122 may mismatch prediction 107, but bias 122 may also mismatch evaluation 113, i.e., the statistical bias 122 did not match the actual evaluation 113 of branch instruction 102. Usefulness counter 210 provides a measure of how useful the statistical bias 122 provided by SCT 120 is, based on observations of whether bias 122 matches or mismatches prediction 107, as well as how bias 122 lines up with the actual evaluation 113 of branch instructions. To avoid needless updates to usefulness counter 210, in exemplary aspects, usefulness counter 210 may be updated only if prediction 107 differs from bias 122. When prediction 107 differs from bias 122, and bias 122 matches evaluation 113, usefulness counter 210 may be incremented. Otherwise, when prediction 107 differs from bias 122, and bias 122 mismatches evaluation 113, usefulness counter 210 may be decremented.

In exemplary aspects, SCT 120 may be designed with a limited number of entries, which means that if SCT 120 is full, then an existing entry may be replaced to make room for an incoming entry. Allocation and replacement of entries of SCT 120 may be performed in the following manner. If a particular branch instruction which is fetched for execution by processor 110 is determined to not already have an entry in SCT 120, then a decision regarding whether or not to allocate an entry in SCT 120 for that branch instruction may be made once evaluation 113 for that branch instruction is known and it is determined from prediction check block 114 whether evaluation 113 matches prediction 107. In an aspect, an entry in SCT 120 may be allocated for the branch instruction if and only if branch prediction mechanism 106 provided an incorrect prediction 107 (i.e., if prediction 107 mismatches evaluation 113).

If an existing entry of SCT 120 is to be replaced to make room for an incoming branch instruction, then usefulness counter 210 for the entry to be replaced (e.g., at a location of SCT 120 indexed by the branch PC of the incoming branch instruction) may be consulted. If the value of usefulness counter 210 is less than zero, this may be taken to mean that the existing entry at the indexed location in SCT 120 is not very useful (in providing a statistical bias which is more useful than prediction 107 from branch prediction mechanism 106 for the corresponding branch instruction associated with the existing entry), and the entry may be replaced to accommodate the incoming branch instruction.

On the other hand, if usefulness counter 210 is greater than or equal zero for the existing entry at the indexed location, then usefulness counter 210 is decremented, but the entry is not replaced. In this manner, usefulness counter 210 may be gradually phased out for the existing entry if the entry continues to not be useful; but if the entry is useful, then usefulness counter 210 will be eventually incremented and may remain in SCT 120. In this manner, relative usefulness may be used as a guide to determine whether particular entries are to be replaced. It is recognized that since some branch instructions with a stronger statistical bias may benefit more from being predicted using bias 122 rather than prediction 107, the above manner of basing retention of entries in SCT 120 for branch instructions whose usefulness counter 210 is greater than zero can lead to retaining only the entries corresponding to the branch instructions which have strong statistical bias (taken or not-taken).

While the above allocation and replacement policies may be more beneficial for larger designs of SCT 120, e.g., containing thousands of entries, for smaller designs, e.g., with a few tens or hundreds of entries, the following alternative policy may be used, wherein entries may be allocated in SCT 120 for only a subset of branch instructions which are mispredicted by branch prediction mechanism 106, for example. For every specified number (say, an integer X) of allocation attempts, only one entry may be allocated (i.e., if X=10, the first 9 allocation attempts by an incoming branch instruction may be ignored or not result in allocation in SCT 120, and the 10th allocation attempt may succeed in getting allocated in SCT 120).

In various other aspects, alternative allocation and replacement policies may also be compatible with this disclosure and may be chosen based on particular design criteria. For instance, a set-associative implementation of SCT 120 may also be used, wherein an entry for a branch may belong to a way of two or more ways in a set, rather than a direct mapped association with one entry for each branch in SCT 120. In another alternative, the branch instructions encountered in a program may be profiled and a selected subset of branch instructions, e.g., the branch instructions which are predominantly or heavily mispredicted may be chosen for inclusion in SCT 120, while remaining branch instructions may not be stored in SCT 120. This way, the number of entries of SCT 120 may be minimized.

In yet another alternative, SCT 120 may be dynamically powered on or off based on program behavior. For instance, a metric such as a number of mispredictions per thousand instructions (or “MPKI”) may be tracked. If, for a previous epoch or program phase, the MPKI is high, this may be an indication that the number of mispredictions contained in prediction 107 provided by branch prediction mechanism 106 was high for the last epoch, and so, SCT 120 may be enabled with a view to reducing the number of mispredictions by using the statistical correction provided by SCT 120. On the other hand, if the MPKI is low for the last epoch, then this may be an indication that branch prediction mechanism 106 was performing with high accuracy and so SCT 120 may be disabled or gated off. In one such implementation, a counter (e.g., a 4-bit signed counter shown as counter 220 in FIG. 2) may be configured to track the performance of SCT 120. Counter 220 may be incremented when SCT 120 was useful in removing a misprediction (e.g., usefulness counter 210 of any entry of SCT 120 was incremented), and decremented when SCT 120 caused a misprediction to occur. If, at a certain program phase, counter 220 was greater than zero, indicating that SCT 120 was useful, then SCT 120 may remain enabled; otherwise, SCT 120 may be disabled. In some aspects, effecting the features of enabling/disabling SCT 120 may be accomplished by the use of known techniques such as power gating or clock gating to reduce the power consumed by SCT 120.

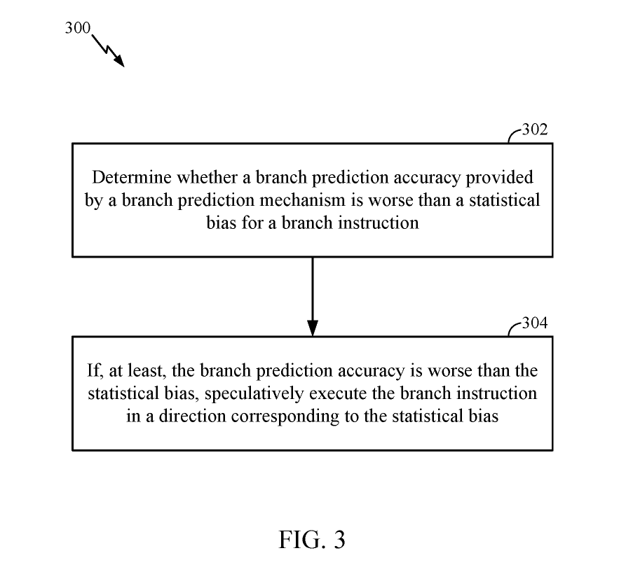

Accordingly, it will be appreciated that exemplary aspects include various methods for performing the processes, functions and/or algorithms disclosed herein. For example, FIG. 3 illustrates a method 300 of branch prediction.

In Block 302, method 300 comprises determining whether a branch prediction accuracy provided by a branch prediction mechanism is worse than a statistical bias for a branch instruction (e.g., from a statistical correction table such as SCT 120 to determine whether the branch prediction accuracy of prediction 107 provided by branch prediction mechanism 106 is worse than the statistical bias 122 for the branch instruction provided by SCT 120). In exemplary aspects, an entry in SCT 120 for the branch instruction, if present, comprises indications of: a number of mispredictions by the branch prediction mechanism for the branch instruction (e.g., misprediction counter 208); a number of times the branch instruction evaluated to a taken direction (e.g., taken counter 204); and a number of times the branch instruction evaluated to a not-taken direction (not-taken counter 206). In exemplary aspects method 300 may further comprise indexing SCT 120 using a program counter value (e.g., 102pc) of the branch instruction, wherein the entry further comprises a tag 202 corresponding to the branch instruction.

In Block 304 if, at least, the branch prediction accuracy is worse than the statistical bias, speculatively executing the branch instruction in a direction corresponding to the statistical bias (e.g., based on one or more additional heuristics such as usefulness counter greater than zero, in addition to whether misprediction counter 208 is greater than the minimum of taken counter 204 and not-taken counter 206, using bias 122 instead of prediction 107 to speculatively execute branch instruction 102).

Further, method 300 may include speculatively executing branch instruction 102 in the direction corresponding to the statistical bias if one or more additional heuristics are satisfied. The one or more additional heuristics may comprise a usefulness indication of the entry, wherein the entry comprises a usefulness counter which is: increased if a branch prediction provided by the branch prediction mechanism differs from the statistical bias and the statistical bias matches the evaluation of the branch instruction, or decreased if the branch prediction provided by the branch prediction mechanism differs from the statistical bias and the statistical bias mismatches the evaluation of the branch instruction. In some aspects, the one or more additional heuristics may comprise: if a branch prediction counter of the branch prediction mechanism corresponding to the branch instruction is not saturated; if the usefulness counter is saturated; or if the accuracy of the branch prediction mechanism during a previous epoch was lower than a specified threshold. The entry in SCT 120 may be replaced if the usefulness counter 210 is less than zero, or the usefulness counter 210 may be decremented if the usefulness counter 210 is greater than or equal to zero.

In some aspects of method 300, allocating an entry in SCT 120 for the branch instruction 102 may occur if branch instruction 102 was mispredicted by branch prediction mechanism 106, and more specifically, in some implementations, an entry in SCT 120 may only be allocated for a subset of branch instructions which are mispredicted by branch prediction mechanism 106. Furthermore, some aspects of method 300 may also include determining whether SCT 120 is useful in improving accuracy of branch prediction based on a performance of SCT 120 (e.g., using counter 220) or a number of mispredictions of branch instructions by the branch prediction mechanism (e.g., MPKI in a previous program phase or epoch, as noted above), and disabling SCT 120 to reduce power consumption (e.g., by clock or power gating) if SCT is not determined to be useful.

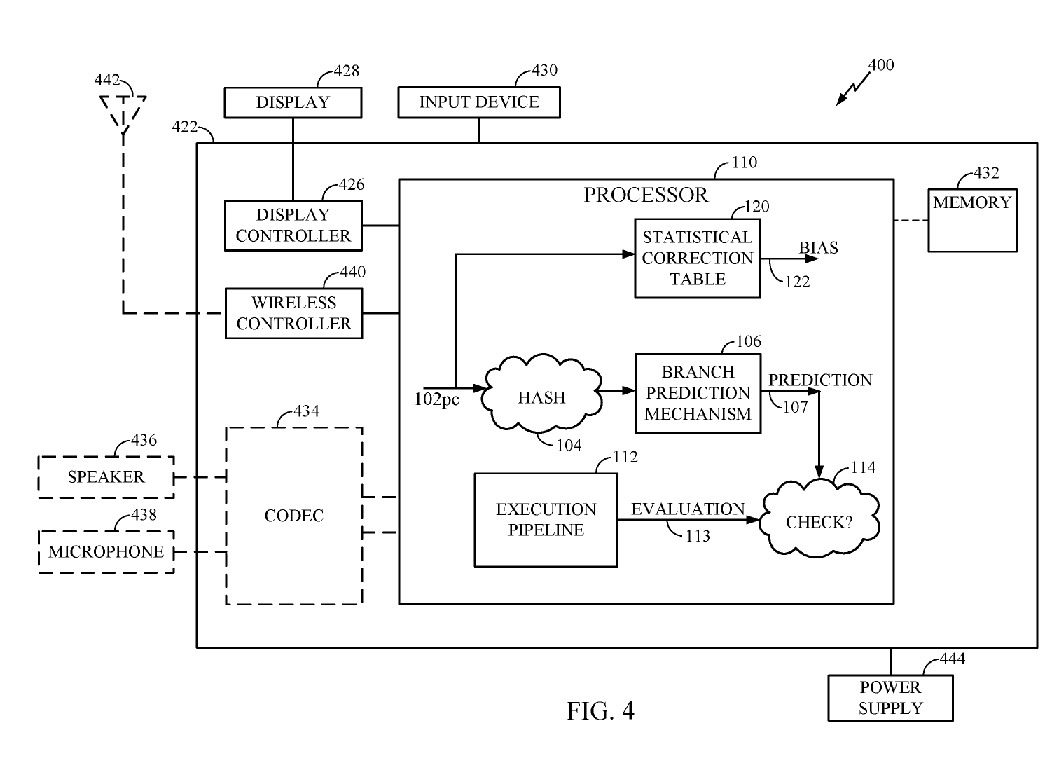

An example apparatus in which exemplary aspects of this disclosure may be utilized, will now be discussed in relation to FIG. 4. FIG. 4 shows a block diagram of computing device 400. Computing device 400 may correspond to an exemplary implementation of a processing system 100 of FIG. 1, wherein processor 110 may be configured to perform method 300 of FIG. 3. In the depiction of FIG. 4, computing device 400 is shown to include processor 110, with only limited details (including SCT 120, branch prediction mechanism 106, execution pipeline 112 and prediction check block 114) reproduced from FIG. 1, for the sake of clarity. Notably, in FIG. 4, processor 110 is exemplarily shown to be coupled to memory 432 and it will be understood that other memory configurations known in the art such as cache 108 have not been shown, although they may be present in computing device 400.

FIG. 4 also shows display controller 426 that is coupled to processor 110 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 110 and speaker 436 and microphone 438 can be coupled to CODEC 434; and wireless antenna 442 coupled to wireless controller 440 which is coupled to processor 110. Where one or more of these optional blocks are present, in a particular aspect, processor 110, display controller 426, memory 432, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 110 and memory 432, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for improving branch prediction accuracy by using a statistical corrector. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of branch prediction, the comprising:
determining whether a branch prediction accuracy provided by a branch prediction mechanism is worse than a statistical bias for a branch instruction; and
if, at least, the branch prediction accuracy is worse than the statistical bias, speculatively executing the branch instruction in a direction corresponding to the statistical bias.

2. The method of claim 1, comprising consulting a statistical correction table (SCT) to determine whether the branch prediction accuracy provided by the branch prediction mechanism is worse than the statistical bias for the branch instruction, wherein an entry in the SCT for the branch instruction, if present, comprises indications of:
a number of mispredictions by the branch prediction mechanism for the branch instruction;
a number of times the branch instruction evaluated to a taken direction; and
a number of times the branch instruction evaluated to a not-taken direction.

3. The method of claim 2, further comprising indexing the SCT using a program counter value of the branch instruction, wherein the entry further comprises a tag corresponding to the branch instruction.

4. The method of claim 2, further comprising speculatively executing the branch instruction in the direction corresponding to the statistical bias if one or more additional heuristics are satisfied.

5. The method of claim 4, wherein the one or more additional heuristics comprise a usefulness indication of the entry, wherein the entry comprises a usefulness counter which is:
increased if a branch prediction provided by the branch prediction mechanism differs from the statistical bias and the statistical bias matches the evaluation of the branch instruction, or
decreased if the branch prediction provided by the branch prediction mechanism differs from the statistical bias and the statistical bias mismatches the evaluation of the branch instruction.

6. The method of claim 5, wherein the one or more additional heuristics comprise:
if a branch prediction counter of the branch prediction mechanism corresponding to the branch instruction is not saturated;
if the usefulness counter is saturated; or
if the accuracy of the branch prediction mechanism during a previous epoch was lower than a specified threshold.

7. The method of claim 4, comprising replacing the entry if the usefulness counter is less than zero, or decrementing the usefulness counter if the usefulness counter is greater than or equal to zero.

8. The method of claim 2, further comprising allocating an entry in the SCT for the branch instruction if the branch instruction was mispredicted by the branch prediction mechanism.

9. The method of claim 2, further comprising allocating an entry in the SCT for a subset of branch instructions which are mispredicted by the branch prediction mechanism.

10. The method of claim 2, further comprising determining whether the SCT is useful in improving accuracy of branch prediction based on a performance of the SCT or a number of mispredictions of branch instructions by the branch prediction mechanism.

11. The method of claim 10, further comprising disabling the SCT to reduce power consumption if the SCT is not determined to be useful.

12. An apparatus comprising:
a processor configured to execute at least one branch instruction, wherein the processor comprises:
a branch prediction mechanism configured to provide a branch prediction for the at least one branch instruction;
a statistical correction table (SCT) configured to indicate whether a branch prediction accuracy of the branch prediction provided by the branch prediction mechanism is worse than a statistical bias for a branch instruction; and
an execution pipeline configured to speculatively execute the branch instruction in a direction corresponding to the statistical bias if, at least, the branch prediction accuracy is worse than the statistical bias.

13. The apparatus of claim 12, wherein the SCT comprises one or more entries, with each entry corresponding to a branch instruction, and wherein an entry in the SCT for the at least one branch instruction, if present, comprises indications of:
a number of mispredictions by the branch prediction mechanism for the at least one branch instruction;
a number of times the at least one branch instruction evaluated to a taken direction; and
a number of times the at least one branch instruction evaluated to a not-taken direction.

14. The apparatus of claim 13, wherein the entry further comprises a tag corresponding to the at least one branch instruction, and wherein the SCT comprises the entry at a location indexed by a program counter value of the branch instruction.

15. The apparatus of claim 13, wherein the execution pipeline is configured to speculatively execute the branch instruction in the direction corresponding to the statistical bias if one or more additional heuristics are satisfied.

16. The apparatus of claim 15, wherein the one or more additional heuristics comprise a usefulness indication of the entry, wherein the entry comprises a usefulness counter which is configured to be:
increased if a branch prediction provided by the branch prediction mechanism differs from the statistical bias and the statistical bias matches the evaluation of the branch instruction, or
decreased if the branch prediction provided by the branch prediction mechanism differs from the statistical bias and the statistical bias mismatches the evaluation of the branch instruction.

17. The apparatus of claim 16, wherein the one or more additional heuristics comprise:
if a branch prediction counter of the branch prediction mechanism corresponding to the branch instruction is not saturated;
if the usefulness counter is saturated; or
if the accuracy of the branch prediction mechanism during a previous epoch was lower than a specified threshold.

18. The apparatus of claim 15, wherein the entry is replaced if the usefulness counter is less than zero, or the usefulness counter is decremented if the usefulness counter is greater than or equal to zero.

19. The apparatus of claim 13, wherein an entry in the SCT is allocated for the at least one branch instruction if the branch instruction was mispredicted by the branch prediction mechanism.

20. The apparatus of claim 13, wherein an entry is allocated in the SCT for a subset of branch instructions which are mispredicted by the branch prediction mechanism.

21. The apparatus of claim 13, further comprising a counter configured to determine whether the SCT is useful in improving accuracy of branch prediction based on a performance of the SCT or a number of mispredictions of branch instructions by the branch prediction mechanism.

22. The apparatus of claim 21, wherein the SCT is configured to be disabled to reduce power consumption if the SCT is not determined to be useful.

23. An apparatus comprising:
means for determining whether a branch prediction accuracy provided by a branch prediction mechanism is worse than a statistical bias for a branch instruction; and
means for speculatively executing the branch instruction in a direction corresponding to the statistical bias if, at least, the branch prediction accuracy is worse than the statistical bias.

24. A non-transitory computer readable storage medium comprising code, which, when executed by a processor causes the processor to perform operations for branch prediction, the non-transitory computer readable storage medium comprising:
code for determining whether a branch prediction accuracy provided by a branch prediction mechanism is worse than a statistical bias for a branch instruction; and
code for speculatively executing the branch instruction in a direction corresponding to the statistical bias if, at least, the branch prediction accuracy is worse than the statistical bias.

25. The non-transitory computer readable storage medium of claim 24, comprising code for consulting a statistical correction table (SCT) to determine whether the branch prediction accuracy provided by the branch prediction mechanism is worse than the statistical bias for the branch instruction, wherein an entry in the SCT for the branch instruction, if present, comprises indications of:
a number of mispredictions by the branch prediction mechanism for the branch instruction;
a number of times the branch instruction evaluated to a taken direction; and
a number of times the branch instruction evaluated to a not-taken direction.

26. The non-transitory computer readable storage medium of claim 25, further comprising code for indexing the SCT using a program counter value of the branch instruction, wherein the entry further comprises a tag corresponding to the branch instruction.

27. The non-transitory computer readable storage medium of claim 25, further comprising code for speculatively executing the branch instruction in the direction corresponding to the statistical bias if one or more additional heuristics are satisfied.

28. The non-transitory computer readable storage medium of claim 27, wherein the one or more additional heuristics comprise a usefulness indication of the entry, wherein the entry comprises a usefulness counter which is:
increased if a branch prediction provided by the branch prediction mechanism differs from the statistical bias and the statistical bias matches the evaluation of the branch instruction, or
decreased if the branch prediction provided by the branch prediction mechanism differs from the statistical bias and the statistical bias mismatches the evaluation of the branch instruction.

29. The non-transitory computer readable storage medium of claim 28, comprising code for replacing the entry if the usefulness counter is less than zero or decrementing the usefulness counter if the usefulness counter is greater than or equal to zero.

30. The non-transitory computer readable storage medium of claim 24, further comprising code for allocating an entry in the SCT for the branch instruction if the branch instruction was mispredicted by the branch prediction mechanism.
